(19) United States
(12) Patent Application Publication
(10) Pub. No.: US 2006/0245185 A1
(43) Pub. Date: Nov. 2, 2006

(54) LAMP STABILIZING CLIP

(76) Inventors: Anthony Tufano, North Massapequa, NY (US); Emma Levin, Brooklyn, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/380,431

(22) Filed: Apr. 27, 2006

Related U.S. Application Data
(60) Provisional application No. 60/676,443, filed on Apr. 29, 2005.

(51) Int. Cl. F21S 4/00

(52) U.S. Cl. 362/217

(57) ABSTRACT

A clip member which, when fastened to a lampholder such as, for example, a G8.5 lampholder, helps to position a lamp to be in alignment with the lampholder and with an associated luminaire. The edges of the recess of the lampholder for receiving the lamp are chamfered to facilitate insertion of a lamp into the lampholder. Proper alignment of a single-ended bi-pin lamp such as a G8.5 lamp is critical to ensure that there is an even distribution of light in all directions when the lamp is energized. The clip member contacts an end of a lamp installed in the lampholder and, together with the spring tabs on the clip, urges a lamp installed in the lampholder to its upright position and, in addition, helps to stabilize it.

This application claims the benefit of U.S. provisional application having Ser. No. 60/676,443, which was filed Apr. 29, 2005.

### BACKGROUND OF THE INVENTION

1. Field of the Invention

The present invention relates to lampholders for electrical lamps.

2. Description of the Prior Art

Modular luminaries or light fixtures are used as indoor accent and display lighting. Further these luminaries can be used for gallery, museum and showroom lighting. In one example, these luminaries are associated with a lampholder which supports a lamp such as a single-ended metal halide lamp having a G8.5 base. To install the lamp, the two prongs of the lamp must be fully inserted into two openings located in a recess of the lampholder. The lamp must be properly aligned with the lampholder and an associated luminarie to ensure an even distribution of light in all directions when the lamp is energized. However, a conventional lampholder may not be capable of properly securing and positioning the lamp to provide for even distribution of light from a luminarie.

Thus, a need exists for a lampholder that can position a single-ended metal halide lamp having a G8.5 base to be in alignment with an associated luminaire.

### SUMMARY OF THE INVENTION

To address the above deficiencies of lampholders, the present invention is a clip member which, when fastened to a lampholder such as, for example, a lampholder for receiving a G8.5 lamp, helps to position a lamp to be in alignment with the lampholder and with an associated luminaire. Proper alignment of a lamp, such as a G8.5 lamp, is critical to ensure that there is an even distribution of light in all directions when the lamp is energized. The clip member can be made of a thin strip of material having a substantially circular shape with two opposing inwardly projecting flexible spring tabs. The clip member can be attached to the lampholder with bushings such as rivets or screws. The clip member contacts an end of a lamp installed in the lampholder and, together with the spring tabs on the clip, urges a lamp installed in the lampholder to its upright position and, in addition, helps to stabilize the lamp by providing a snug fit. The clip is composed of a high temperature material that will not take “a set” and be distorted out of its proper shape over time, particularly when exposed to high temperatures.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiments as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 is a perspective view of a lampholder assembly having a clip member according to an embodiment of the invention; and

FIG. 2 is a perspective view of the lampholder assembly of FIG. 1 with a lamp.

### DETAILED DESCRIPTION

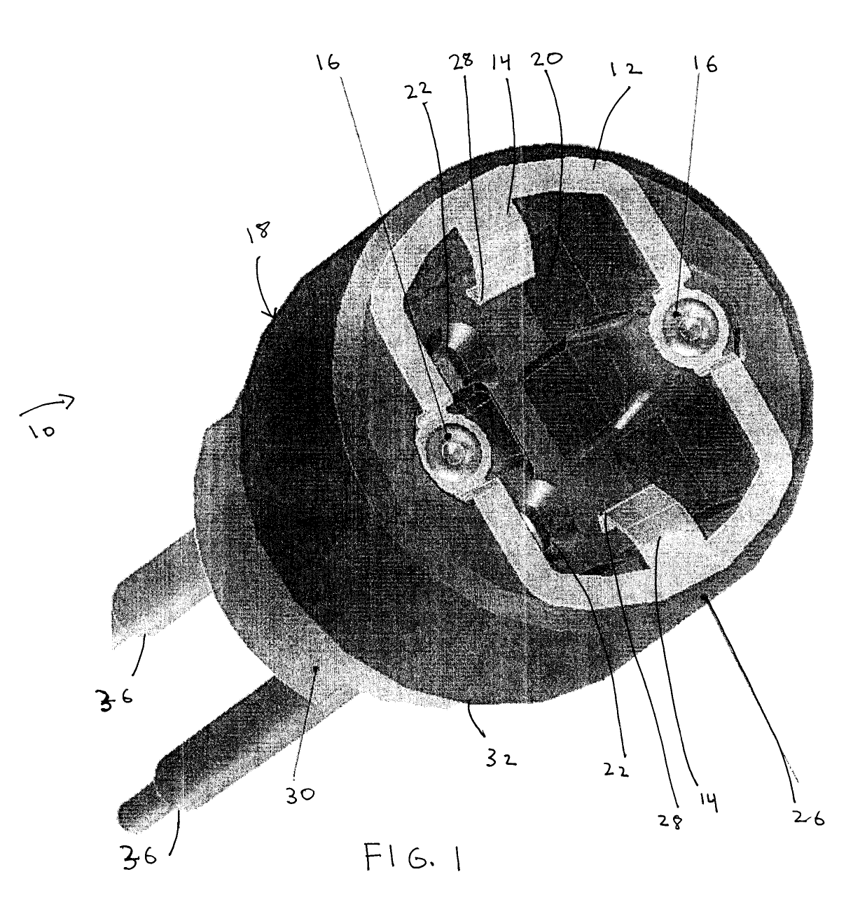

FIG. 1 shows a lampholder assembly 10 comprising a clip member 12 which, when fastened to lampholder 18 helps to position a lamp (not shown) to be in alignment with the lampholder and with associated luminaire (not shown). The clip member 12 is made of a relatively thin strip of material having a substantially circular shape with two inwardly projecting flexible spring tabs 14 spaced approximately 180 degrees apart. The spring tabs 14 have contact portions 28 which are arranged to contact the base portion of a lamp and provide a snug fit thereto. A recess 20 located within the top portion 32 of the lampholder 18 includes two openings 22 which support the two prongs of a lamp (not shown). Power conductors 36 extend from the bottom portion 30 of the lampholder 18 and deliver power from a power source (not shown) to the prongs (not shown) of the lamp 24 through contacts located in the openings 22. The clip member 12 is attached to and spaced from the top surface 26 of the lampholder 18 with bushings 16 such as rolled over rivets but other attachment means can be used. The clip member 12 is composed of a high temperature material that will not be substantially affected by heat when exposed to high temperatures such as from a lamp when it is energized. The lampholder 18 is composed of ceramic or other material to withstand high temperatures.

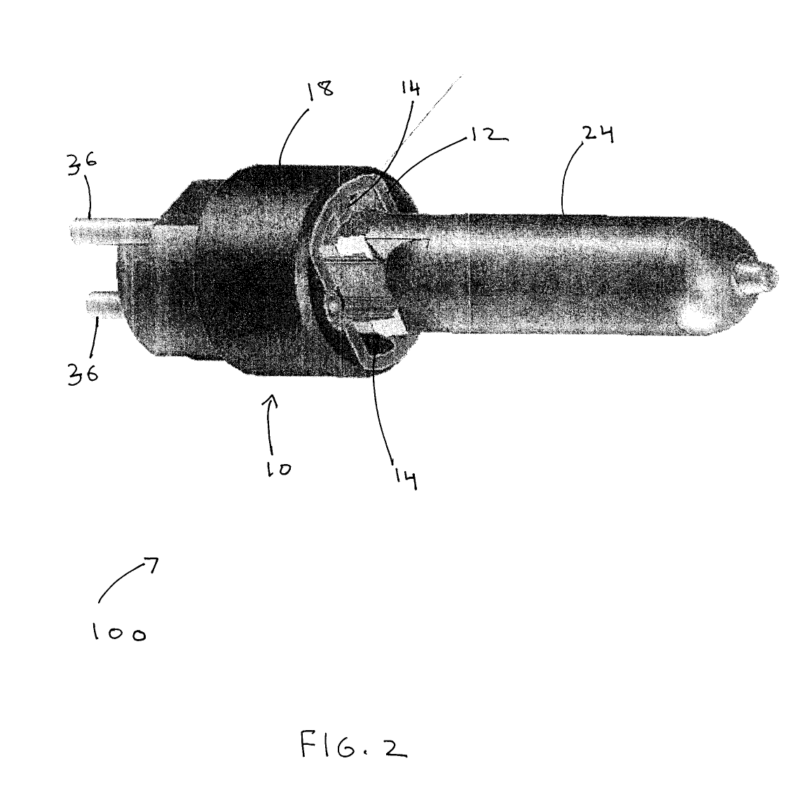

FIG. 2 shows a lampholder system 100 comprising the assembly 10 of FIG. 1 with a lamp 24 installed in its upright position. To install the lamp 24, the two prongs (not shown) of the lamp are fully inserted into the two openings 22 (FIG. 1) in the recess of the body of the lampholder 18. The contact portions 28 (FIG. 1) of the spring tabs 14 makes contact with the bottom portion of the lamp 24 and urges it to its upright position and helps to stabilize it. The clip member 12 helps to position the lamp 24 to be in alignment with the lampholder which is critical to ensure that there is an even distribution of light in all directions when the lamp is energized and located in a luminarie. The lampholder 18 is shown as a standard G8.5 lampholder and the lamp 24 as a standard G8.5 base lamp but other types of lampholders and lamps can be used with the clip member 12 of the present invention. The lampholder assembly 10 can be combined with a luminarie or light fixture as part of indoor accent or display lighting arrangement.

While there have been shown and described and pointed out the fundamental novel features of the invention as applied to the various embodiments, as is presently contemplated for carrying them out, it will be understood that various omissions and substitutions and changes of the form and details of the device illustrated and in its operation may be made by those skilled in the art, without departing from the spirit of the invention.

What is claimed is:

1. A member adapted to be coupled to a lampholder comprising:
a ring shaped clip member having at least first and second inwardly projecting flexible members, wherein said clip member is configured for coupling to a surface of said lampholder which has openings for receiving contacts of a lamp.

2. The member of claim 1 wherein the first and second inwardly projecting flexible members are spring tabs spaced approximately 180 degrees apart.

3. The member of claim 1 wherein the clip member is adapted to be attached to the lampholder with bushings.

4. The member of claim 1 wherein the clip member is composed of material that will not be substantially affected by heat from the lamp when the lamp is energized.

5. The member of claim 1 wherein the clip member positions a lamp in the upright with respect to a top surface of the lampholder to permit an even distribution of light in all directions when the lamp is energized.

6. The member of claim 1 wherein the clip member is adapted to engage a single-ended metal halide lamp having a G8.5 base.

7. A clip comprising:
a ring shaped member having at least first and second inwardly projecting flexible members, wherein said ring shaped member is configured for coupling to a surface of a lampholder which has openings for receiving contacts of a lamp.
